(19) United States
(12) Patent Application Publication
(10) Pub. No.: US 2024/0329325 A1
(43) Pub. Date: Oct. 3, 2024

(54) OPTICAL SWITCH AND OPTICAL SWITCH SYSTEM

(71) Applicant: NIPPON TELEGRAPH AND TELEPHONE CORPORATION, Tokyo (JP)

(72) Inventors: Tatsuya FUJIMOTO, Musashino-shi, Tokyo (JP); Kazunori KATAYAMA, Musashino-shi, Tokyo (JP); Ryo KOYAMA, Musashino-shi, Tokyo (JP); Kazuhide NAKAE, Musashino-shi, Tokyo (JP); Hiroshi WATANABE, Musashino-shi, Tokyo (JP); Yoshiteru ABE, Musashino-shi, Tokyo (JP); Tomohiro KAWANO, Musashino-shi, Tokyo (JP); Chisato FUKAI, Musashino-shi, Tokyo (JP)

(73) Assignee: NIPPON TELEGRAPH AND TELEPHONE CORPORATION, Tokyo (JP)

(21) Appl. No.: 18/697,568

(22) PCT Filed: Oct. 11, 2021
(86) PCT No.: PCT/JP2021/037544

§ 371 Date: Apr. 1, 2024

(51) Int. Cl. G02B 6/35

(52) U.S. Cl. CPC G02B 6/3566; G02B 6/3582; G02B 6/3588

(57) ABSTRACT

An object of the present disclosure is to provide an optical switch that does not require power supply.

The present disclosure is an optical switch including: an optical drive unit including an optical expansion body that expands by irradiation with light and contracts by blocking of light, a knock rod that converts the expansion and contraction of the optical expansion body into linear motion that reciprocates by a certain distance, and a rotary moving body that includes a rotor, and converts the linear motion into rotary motion that rotates by a certain angle about an axis of the rotor in accordance with the linear motion that reciprocates by a certain distance by the knock rod; and an optical switching unit including a first optical connection body to which one switching target optical fiber is fixed, a second optical connection body to which each optical fiber of a switching target optical fiber group is fixed, and a connection rotation body that is fixed to the rotor of the rotary moving body, rotates about the axis of the rotor, and switches and connects the one switching target optical fiber fixed to the first optical connection body in contact with one end surface and one optical fiber in the switching target optical fiber group fixed to the second optical connection body in contact with the other end surface.

### TECHNICAL FIELD

The present disclosure relates to an optical switch and an optical switch system used for switching an optical path.

### BACKGROUND ART

Various systems have been suggested for an all-optical switch that performs path switching while keeping light as it is (see Non Patent Literature 1, for example). Among these systems, an optical fiber-type mechanical optical switch that controls abutment between optical fibers or optical connectors with a robot arm, a motor, or the like is inferior to other systems in terms of low switching speed, but has many aspects superior to other systems in terms of low loss, low wavelength dependence, multi-port properties, and a self-holding function of holding a switching state at a time when a power supply is stopped.

Representative examples of such structures include a system in which a stage using an optical fiber V-shaped groove is moved in parallel, for example, a system in which a mirror or a prism is moved in parallel or is made to change its angle so as to selectively couple an incident optical fiber with a plurality of emission optical fibers, and a system in which a jumper cable having an optical connector is connected using a robot arm.

### CITATION LIST

### Non Patent Literature

Non Patent Literature 1: M. Ctepanovsky, “A Comparative Review of MEMS-Based Optical Cross-Connects for All-Optical Networks From the Past to the Present Day,” IEEE Communications Surveys & Tutorials, vol. 21, no. 3, pp. 2928-2946, 2019.

### SUMMARY OF INVENTION

### Technical Problem

However, the conventional technology disclosed in Non Patent Literature 1 above has a problem in that it is difficult to further lower power consumption, reduce size, and lower costs. Specifically, in the above-described system that moves a stage having an optical fiber V-shaped groove or a prism in parallel, a motor is normally used as a drive source. However, since the mechanism linearly moves a heavy object such as a stage, a torque of a certain level or higher is required for the motor, and power consumption for obtaining an appropriate output is required to maintain the necessary torque.

Further, since optical axis alignment using a single-mode optical fiber requires an accuracy of about 1 μm or less, it is required to have a mechanism that converts rotary motion of the motor into linear motion, for example, it is required to convert the rotary motion of the motor into linear motion in submicron steps when using a ball screw. An optical fiber pitch of an optical fiber array on an output side, which is usually used, is about 125 μm of a cladding outer diameter of the optical fiber or about 250 μm in a coating outer diameter of the optical fiber.

If the number of installed optical fibers is increased while this optical fiber pitch is maintained, the optical fiber array on the output side becomes larger. As a result, there are problems that the distance of linear motion becomes longer, an actual drive time of the motor needs to be made longer, and the power consumption becomes higher. Therefore, such an optical fiber-type mechanical optical switch requires power of several hundreds of mW or more. Further, there is also a problem that the robot arm system using an optical connector requires a large amount of power, like several tens of watts or more, for the robot arm that controls insertion and removal of the optical connector or a ferrule. In an environment where power supply is difficult, such as an outdoor overhead optical connection point, it is difficult to secure sufficient power to drive these optical switches.

Therefore, in order to solve the above-described problems, an object of the present disclosure is to provide an optical switch that does not require power supply, and an optical switch system that operates with low power consumption using the optical switch.

### Solution to Problem

To solve the above problems, the optical switch of the present disclosure is configured to generate rotary motion from linear motion and switch and connect optical fibers by the rotary motion, using an optical expansion body that expands and contracts by light irradiation and blocking.

Specifically, the present disclosure includes
an optical switch including:
an optical drive unit including
an optical expansion body that expands by irradiation with light and contracts by blocking of light,
a knock rod that converts the expansion and contraction of the optical expansion body into linear motion that reciprocates by a certain distance, and
a rotary moving body that includes a rotor, and converts the linear motion into rotary motion that rotates by a certain angle about an axis of the rotor in accordance with the linear motion that reciprocates by a certain distance by the knock rod; and
an optical switching unit including
a first optical connection body to which one switching target optical fiber is fixed,
a second optical connection body to which each optical fiber of a switching target optical fiber group is fixed, and
a connection rotation body that is fixed to the rotor of the rotary moving body, rotates about the axis of the rotor, and switches and connects the one switching target optical fiber fixed to the first optical connection body in contact with one end surface and one optical fiber in the switching target optical fiber group fixed to the second optical connection body in contact with the other end surface.

With such a structure, the optical switch of the present disclosure can be configured not to require power supply.

Further, the optical switch of the present disclosure is characterized in that
the rotary moving body includes
a blade fixed to an end surface of the rotor on a side of the knock rod and having a tip with a flat slope on the side of the knock rod,
a cylindrical cam that is fixed inside a housing and receives the slope of the blade with a slope of a sawtooth groove provided in an annular shape in an end surface on a side of the blade and having an inclination in a same direction as the slope of the blade, and
an elastic body that is fixed to the housing and pushes the rotor back toward the cam,
the knock rod is a sawtooth groove that reciprocates inside a cylindrical shape of the cam, and has a groove in an annular shape in an end surface on the side of the blade, the groove being a sawtooth groove shifted by a half pitch at a same cycle as the sawtooth groove of the cam, and having a slope with an inclination in a same direction as the slope of the blade,
when the optical expansion body is contracted, the slope of the blade is pressed against the slope of the sawtooth groove of the cam by the elastic body,
when the optical expansion body expands, the knock rod advances toward the rotor, the slope of the sawtooth groove of the knock rod is pressed against the slope of the blade, and the pressed slope of the blade slides on the slope of the sawtooth groove of the knock rod, so that the rotor rotates, and
when the optical expansion body turns from expansion to contraction, the knock rod retracts from the rotor, the rotor pushed back by the elastic body faces the cam, the slope of the blade is pressed against the slope of the sawtooth groove of the cam, and the pressed slope of the blade slides on the slope of the sawtooth groove of the cam, so that the rotor rotates.

Further, the optical switch of the present disclosure is characterized in that
the optical expansion body is made of a black material or a material containing air bubbles inside the material.

Further, the optical switch of the present disclosure is characterized in that
the connection rotation body includes a connection optical path that connects a center of rotation of the one end surface perpendicular to an axis and a connection point disposed on a circumference having a radius of a predetermined distance from a center of rotation of the other end surface perpendicular to the axis,
the first optical connection body is in contact with the one end surface of the connection rotation body and fixes the one switching target optical fiber at a position facing the center of rotation of the connection rotation body,
the second optical connection body is in contact with the other end surface of the connection rotation body and fixes the optical fibers of the switching target optical fiber group on a circumference having a radius of a predetermined distance from the center of rotation of the connection rotation body, and
the connection optical path switches and connects the one switching target optical fiber of the first optical connection body and one optical fiber in the switching target optical fiber group of the second optical connection body when the connection rotation body rotates.

Further, the optical switch of the present disclosure is characterized in that
the connection rotation body further includes a plurality of monitoring optical paths that connects the one end surface and the other end surface, and has different connection and blocking patterns depending on a rotation angle,
the second optical connection body further fixes a plurality of monitoring transmission optical fibers that transmits the monitoring light from the other end surface of the connection rotation body toward the monitoring optical paths,
the first optical connection body further fixes a plurality of monitoring reception optical fibers that receives the monitoring light from the monitoring optical paths toward the one end surface of the connection rotation body, and
each of the connection and blocking patterns of light from the plurality of monitoring transmission optical fibers to the plurality of monitoring reception optical fibers is uniquely changed by the rotation of the connection rotation body.

Further, the optical switch of the present disclosure is characterized in that
the connection rotation body further includes, on the one end surface, a reflection plate having a reflection and blocking pattern different depending on the rotation angle,
the second optical connection body further fixes a plurality of monitoring transmission/reception optical fibers that transmits the monitoring light from the other end surface of the connection rotation body toward the reflection plate and receives the reflected monitoring light from the reflection plate toward the other end surface of the connection rotation body, and
each of reflection and non-reflection patterns of light in the plurality of monitoring transmission/reception optical fibers is uniquely changed by the rotation of the connection rotation body.

To solve the above problems, the optical switch system of the present disclosure is configured to generate rotary motion from linear motion and switch and connect optical fibers by the rotary motion, using an optical expansion body that expands and contracts by irradiation and blocking of light from a control device.

Specifically, the present disclosure includes
an optical switch system including:
the optical switch according to any one of the above description; and
a control device including a driving light source that supplies light for causing expansion to the optical expansion body and a control unit that instructs the driving light source to perform irradiation and blocking.

Specifically, the present disclosure includes
an optical switch system including:
the optical switch according to the above description; and
a control device including
a driving light source that supplies light for causing expansion to the optical expansion body,
a monitoring light source that transmits monitoring light toward the optical switching unit, a monitoring optical receiver that receives the monitoring light from the optical switching unit, and
a control unit that instructs the driving light source to perform irradiation and blocking, instructs the monitoring light source to perform supply and blocking, and monitors which optical fiber of the switching target optical fiber group is connected to and disconnected from the switching target optical fiber according to a signal from the monitoring optical receiver.

With such a structure, the optical switch system of the present disclosure can operate with low power consumption because of using the optical switch that does not require power supply.

Note that the above disclosed inventions can be combined to any extent possible.

### Advantageous Effects of Invention

According to the present disclosure, it is possible to provide an optical switch that does not require power supply and operates with low power consumption, and an optical switch system using the optical switch.

### BRIEF DESCRIPTION OF DRAWINGS

FIG. 1 is a diagram for describing a configuration of an optical switch system of the present disclosure.

FIG. 2 is a view for describing a configuration of an optical switch of the present disclosure.

FIG. 3 is a view for describing a configuration of an optical drive unit of the present disclosure.

FIG. 4 is a diagram for describing a configuration of an optical expansion body of the present disclosure.

FIG. 5A is views for describing a configuration of a knock rod of the present disclosure.

FIG. 5B is a view for describing the configuration of the knock rod of the present disclosure.

FIG. 6A is views for describing a configuration of a cam of the present disclosure.

FIG. 6B is a view for describing the configuration of the cam of the present disclosure.

FIG. 7A is views for describing a configuration of a housing of the present disclosure.

FIG. 7B is a view for describing the configuration of the housing of the present disclosure.

FIG. 8A is views for describing a configuration of a rotary moving body of the present disclosure.

FIG. 8B is a view for describing the configuration of the rotary moving body of the present disclosure.

FIG. 9 is a view for describing an operation of the optical drive unit of the present disclosure.

FIG. 10 is a view for describing the operation of the optical drive unit of the present disclosure.

FIG. 11 is a view for describing the operation of the optical drive unit of the present disclosure.

FIG. 12A is views for describing a configuration of an optical switching unit of the present disclosure.

FIG. 12B is a view for describing the configuration of the optical switching unit of the present disclosure.

FIG. 13A is views for describing a configuration of a monitoring function of the present disclosure.

FIG. 13B is a view for describing the configuration of the monitoring function of the present disclosure.

FIG. 14 is a diagram for describing a configuration of an optical switch system of the present disclosure.

FIG. 15 is a view for describing a configuration of an optical switch of the present disclosure.

FIG. 16A is views for describing a configuration of a monitoring function of the present disclosure.

FIG. 16B is a view for describing the configuration of the monitoring function of the present disclosure.

### DESCRIPTION OF EMBODIMENTS

Embodiments of the present disclosure will be described below in detail with reference to the drawings. The present disclosure is not limited to the embodiments to be described below. These embodiments are merely examples, and the present disclosure can be carried out in forms of various modifications and improvements based on knowledge of those skilled in the art. Note that components having the same reference numerals in the present specification and the drawings represent the same components.

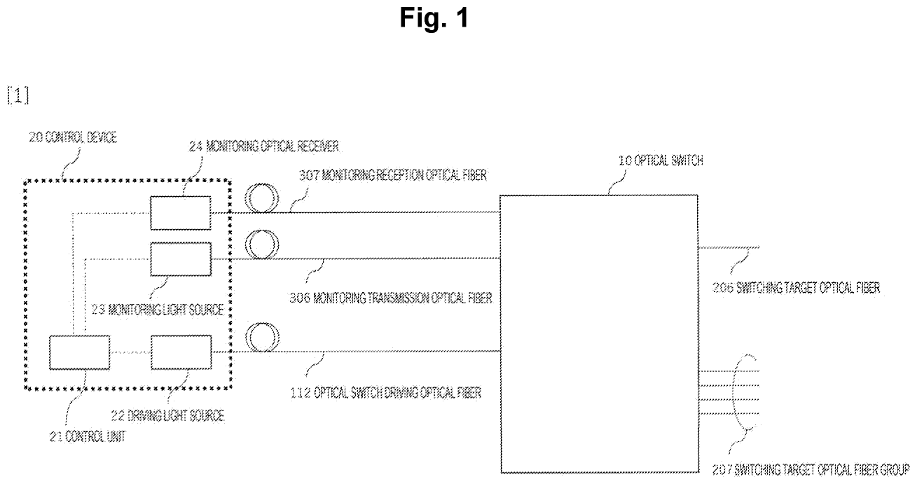

A configuration of an optical switch system of the present disclosure is illustrated in FIG. 1. In FIG. 1, reference numeral 10 denotes an optical switch, reference numeral 112 denotes an optical switch driving optical fiber, reference numeral 20 denotes a control device, reference numeral 21 denotes a control unit, reference numeral 22 denotes a driving light source, reference numeral 23 denotes a monitoring light source, reference numeral 24 denotes a monitoring optical receiver, reference numeral 206 denotes a switching target optical fiber, reference numeral 207 denotes a switching target optical fiber group, reference numeral 306 denotes a monitoring transmission optical fiber, and reference numeral 307 denotes a monitoring reception optical fiber.

The optical switch system includes the optical switch 10 and the control device 20. The control device 20 includes the control unit 21 and the driving light source 22. The control device 20 may further include the monitoring light source 23 and the monitoring optical receiver 24 as monitoring functions.

The control unit 21 instructs the driving light source 22 to perform irradiation or blocking of driving light. The driving light source 22 supplies the driving light to the optical switch 10 through the optical switch driving optical fiber 112. By irradiation or blocking the light of the driving light source 22, the optical switch 10 switches and connects the switching target optical fiber 206 and one optical fiber in the switching target optical fiber group 207. The optical switch 10 does not use a power source, and is controlled by light sent from the control device 20 that can use the power source via the optical switch driving optical fiber 112.

In a case of exerting the monitoring function, the control unit 21 causes the monitoring light source 23 to transmit monitoring light. The monitoring light source 23 supplies the monitoring light to the optical switch 10 through the monitoring transmission optical fiber 306. The monitoring optical receiver 24 receives the monitoring light from the optical switch 10 through the monitoring reception optical fiber 307. The control unit 21 receives a reception signal from the monitoring optical receiver 24 and monitors whether the optical switch 10 is operating as instructed.

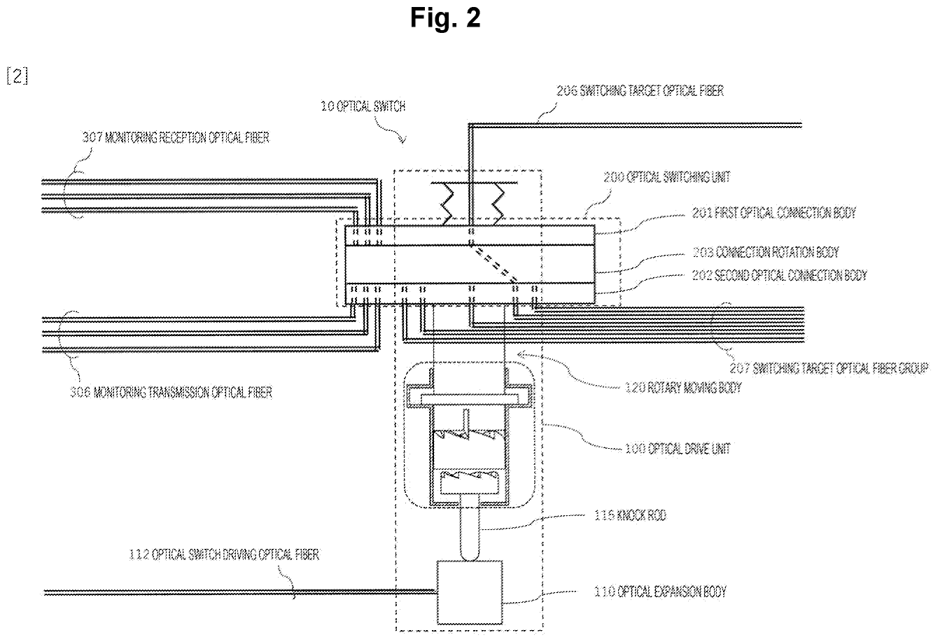

A configuration of the optical switch of the present disclosure is illustrated in FIG. 2. In FIG. 2, reference numeral 10 denotes the optical switch, reference numeral 100 denotes an optical drive unit, reference numeral 110 denotes an optical expansion body, reference numeral 112 denotes the optical switch driving optical fiber, reference numeral 115 denotes a knock rod, reference numeral 120 denotes a rotary moving body, reference numeral 200 denotes an optical switching unit, reference numeral 201 denotes a first optical connection body, reference numeral 202 denotes a second optical connection body, reference numeral 203 denotes a connection rotation body, reference numeral 206 denotes the switching target optical fiber, reference numeral 207 denotes the switching target optical fiber group, reference numeral 306 denotes the monitoring transmission optical fiber, and reference numeral 307 denotes the monitoring reception optical fiber. The optical switch 10 includes the optical drive unit 100 and the optical switching unit 200. Note that FIG. 2 is a view in which an inside of the housing is seen through only within the dotted line of the optical drive unit 100.

When the optical expansion body 110 of the optical drive unit 100 is irradiated with the driving light via the optical switch driving optical fiber 112 and then the driving light is blocked, the optical expansion body 110 expands and contracts according to the irradiation and blocking. The knock rod 115 converts the expansion and contraction of the optical expansion body 110 into linear motion that reciprocates by a certain distance. The rotary moving body 120 in the optical drive unit 100 converts the linear motion of the knock rod 115 into rotary motion that rotates by a certain angle. With the rotation, the connection rotation body 203 in the optical switching unit 200 rotates, so that one optical fiber of the switching target optical fiber group 207 fixed to the second optical connection body 202 and the switching target optical fiber 206 fixed to the first optical connection body 201 are switched and connected.

In a case where the optical switch has the monitoring function, when the rotary moving body 120 of the optical drive unit 100 converts the linear motion into the rotary motion that rotates by a certain angle, the connection rotation body 203 in the optical switching unit 200 rotates by a certain angle with the rotation. It is possible to detect a rotation angle of the connection rotation body 203 in the optical switching unit 200 when light enters the connection rotation body 203 from the monitoring transmission optical fiber 306, and depending on how the light is connected and blocked and enters the monitoring reception optical fiber 307. Therefore, the control device 20 can monitor which optical fiber in the switching target optical fiber group 207 is switched and connected with the switching target optical fiber 206 by the optical switch 10 as instructed.

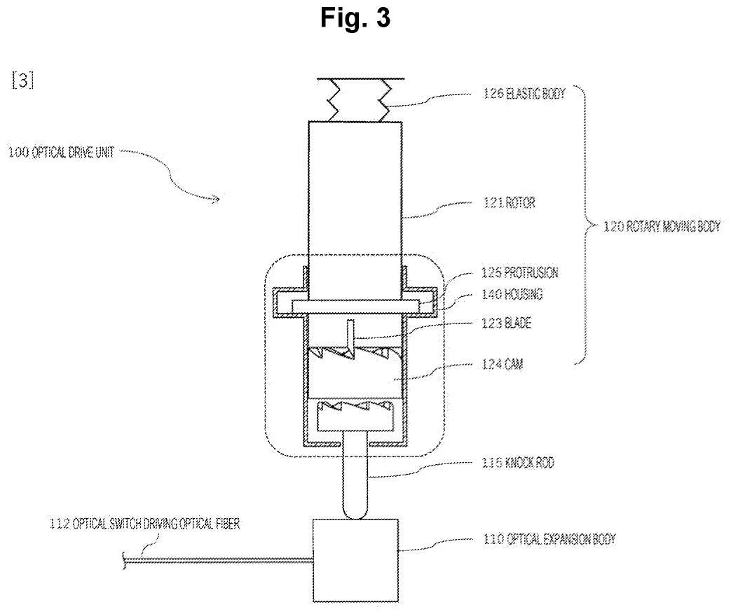

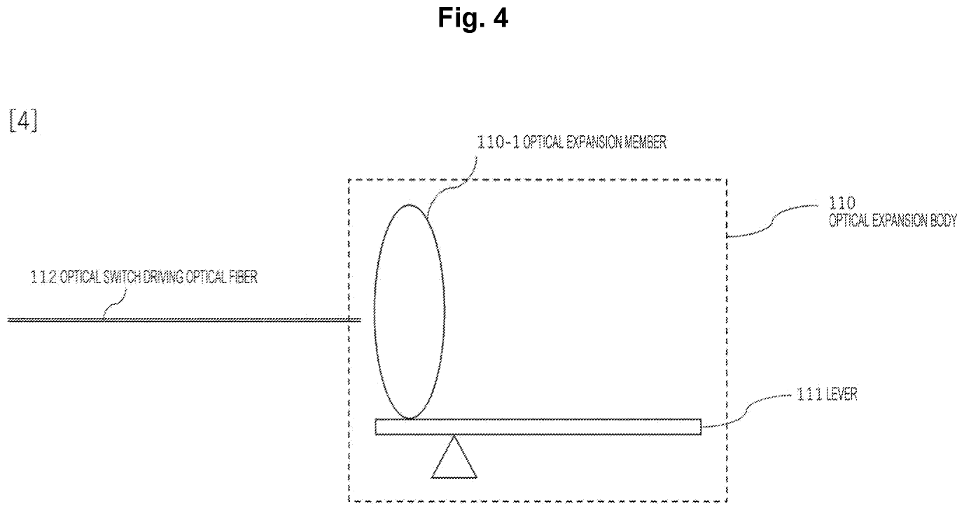

A configuration of the optical drive unit of the present disclosure is illustrated in FIG. 3. Configurations of the optical expansion body, the knock rod, a cam, the housing, and the rotary moving body of the optical drive unit of the present disclosure are illustrated in FIGS. 4 to 8B. In FIGS. 3 to 8B, reference numeral 100 denotes the optical drive unit, reference numeral 110 denotes the optical expansion body, reference numeral 110-1 denotes an optical expansion member, reference numeral 111 denotes a lever, reference numeral 112 denotes the optical switch driving optical fiber, reference numeral 115 denotes the knock rod, reference numeral 115-1 denotes the groove of the knock rod, reference numeral 115-2 denotes a pressing portion, reference numeral 120 denotes the rotary moving body, reference numeral 121 denotes a rotor, reference numeral 122 denotes a rotor gear, reference numeral 123 denotes a blade, reference numeral 124 denotes a cam, reference numeral 124-1 denotes a groove of the cam, reference numeral 124-2 denotes a knock hole of the cam, reference numeral 125 denotes a protrusion, 126 denotes an elastic body, reference numeral 127 denotes a shaft hole, reference numeral 140 denotes a housing, reference numeral 141 denotes a rotor hole, reference numeral 142 denotes a recess, and reference numeral 143 denotes a knock hole of the housing. Note that FIG. 3 is a view in which the inside of the housing 140 is seen through only within the dotted line of the optical drive unit 100.

In FIG. 3, the optical expansion body 110 expands when irradiated with the driving light supplied from the optical switch driving optical fiber 112 and contracts when the light is blocked. The material of the optical expansion body 110 is a member that expands when irradiated with light and contracts when the light is blocked. An example of the material that is likely to expand includes polymer molecules. It is desirable that a black material, for example, charcoal, is kneaded into the material that is likely to expand such as the polymer molecules. When a black substance is irradiated with light, it becomes easy to convert light into heat. By transferring the heat to the polymer of the black substance, the polymer undergoes thermal expansion. Further, thermal expansion of air may also be utilized using foamable polymers containing air bubbles therein.

An example of the configuration of the optical expansion body is illustrated in FIG. 4. Since a substantial change occurs due to thermal expansion, expansion and contraction of the optical expansion member 110-1 may be amplified using the lever 111 as illustrated in FIG. 4.

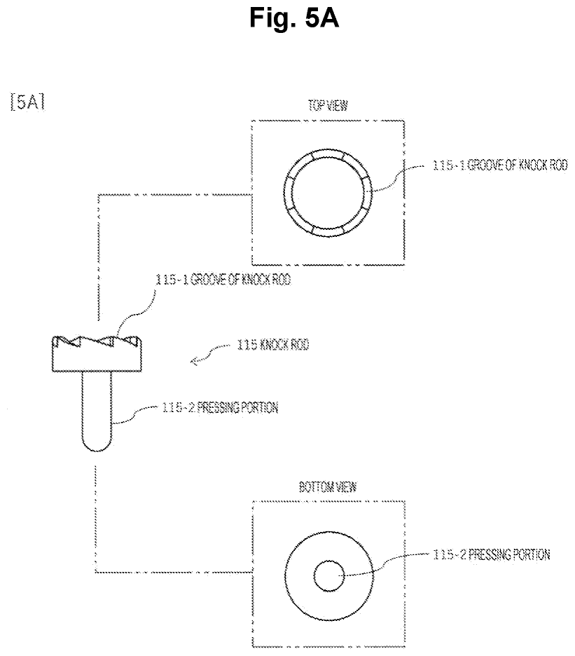

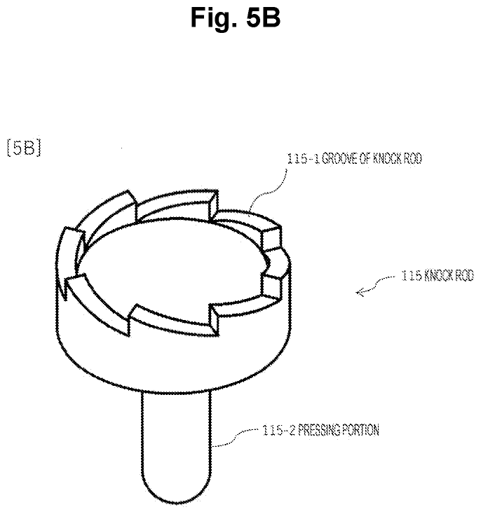

An example of a configuration of the knock rod is illustrated in FIGS. 5A and 5B. FIG. 5A is a front view, a top view, and a bottom view of the knock rod, and FIG. 5B is a perspective view of the knock rod. In FIGS. 3, and 5A and 5B, the pressing portion 115-2 of the knock rod 115 converts the expansion and contraction into linear motion that reciprocates by a certain distance inside the knock hole 124-2 of the cam in accordance with the expansion and contraction of the optical expansion body 110. Specifically, the knock rod 115 has the groove 115-1 of the knock rod in an annular shape in an end surface on a side of the blade 123. The groove 115-1 of the knock rod has a sawtooth shape. The period of the groove 115-1 of the knock rod is the same as the period of the groove 124-1 of the cam of the cam 124, and is shifted by a half pitch. The slope of the groove 115-1 of the knock rod has the inclination in the same direction as the slope of the blade 123 in order to receive the blade 123 when pushing up the rotor 121.

The rotary moving body 120 converts the linear motion into rotary motion that rotates by a certain angle in accordance with the linear motion of the knock rod 115 that reciprocates by a certain distance. Specifically, the rotary moving body 120 includes the rotor 121, the rotor gear 122, the blade 123, the cam 124, the protrusion 125, the elastic body 126, and the housing 140.

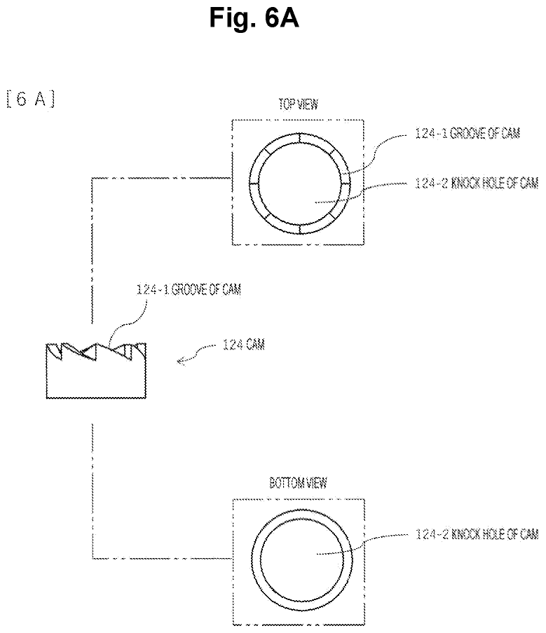

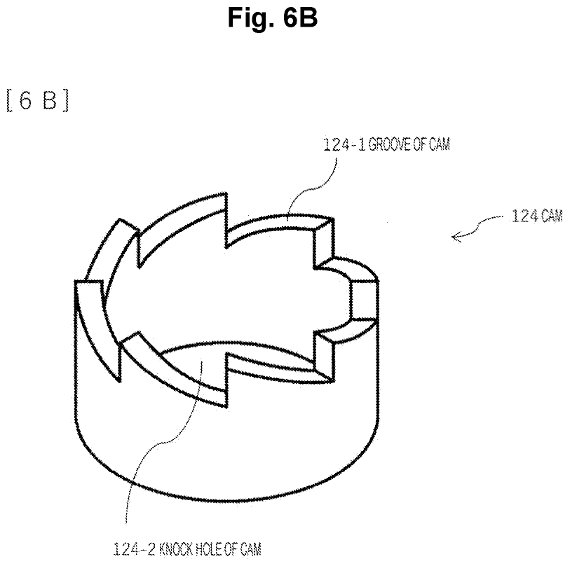

An example of a configuration of the cam is illustrated in FIGS. 6A and 6B. FIG. 6A is a front view, a top view, and a bottom view of the cam, and FIG. 6B is a perspective view of the cam. In FIGS. 3, and 6A and 6B, the cam 124 has a cylindrical shape in which the knock rod 115 reciprocates in the knock hole 124-2 of the cam inside, and is fixed inside the housing 140. The groove 124-1 of the cam is provided in an annular shape in the end surface on the side of the blade 123. The groove 124-1 of the cam has a sawtooth shape. The period of the groove 124-1 of the cam is the same as that of the groove 115-1 of the knock rod, and is shifted by a half pitch. The slope of the groove 124-1 of the cam has the inclination in the same direction as the slope of the blade 123 in order to receive the blade 123 of the rotor 121.

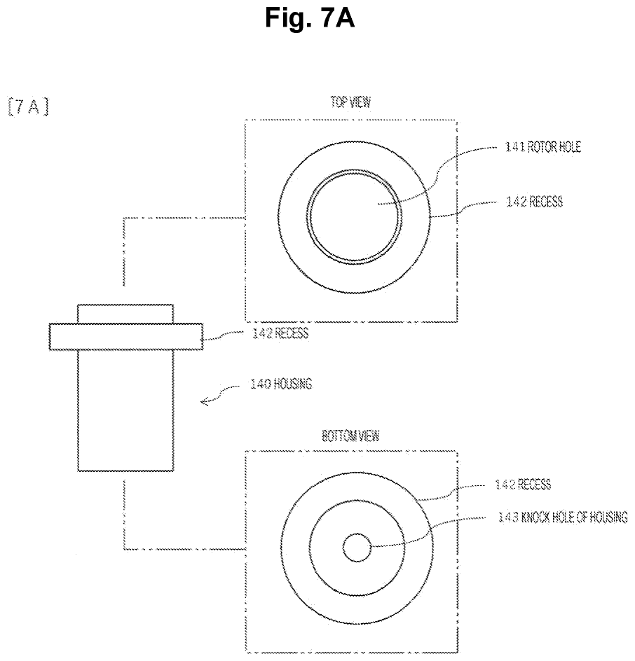

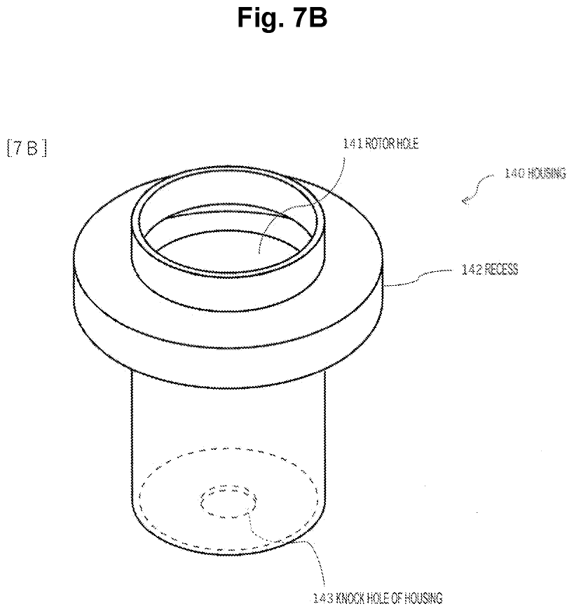

An example of a configuration of the housing is illustrated in FIGS. 7A and 7B. FIG. 7A is a front view, a top view, and a bottom view of the housing, and FIG. 7B is a perspective view of the housing. In FIGS. 3, and 7A and 7B, the housing 140 has the rotor hole 141, the recess 142, and the knock hole 143 of the housing. The housing 140 supports the rotor 121 with the rotor hole 141 and stabilizes the rotary motion of the rotor 121. The housing 140 fixes the cam 124 therein. The housing 140 supports the knock rod 115 inside with the knock hole 143 of the housing and stabilizes the linear motion of the knock rod 115. The elastic body 126 is fixed to a part of the housing 140, and the elastic body 126 pushes the rotor 121 back toward cam 124.

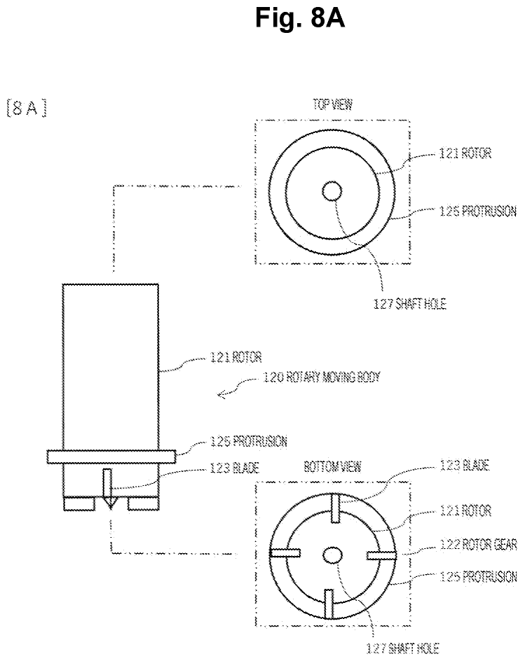

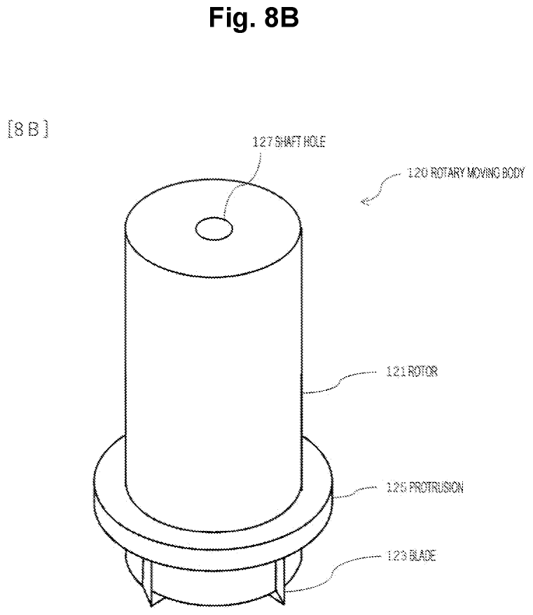

FIGS. 8A and 8B illustrate an example of a part of the configuration of the rotary moving body. FIG. 8A is a front view, a top view, and a bottom view of the rotary moving body, and FIG. 8B is a perspective view of the rotary moving body. In FIGS. 3, and 8A and 8B, the rotor 121 rotates about the shaft hole 127 inside the housing 140. The blade 123 is fixed to the end surface of the rotor 121 on the side of the knock rod 115, and a tip on the side of the knock rod 115 is a flat slope. The slope of the blade 123 has an inclination in the same direction as the slope of the groove 115-1 of the sawtooth knock rod and the slope of the groove 124-1 of the sawtooth cam. An inclination angle of the slope of the blade 123 is desirably at the same level as the inclination angle of the slope of the sawtooth groove 115-1 of the knock rod and the inclination angle of the slope of the sawtooth groove 124-1 of the cam. The protrusion 125 of the rotor has a degree of freedom in the same direction as the linear motion of the knock rod 115 within a range of an internal size of the recess 142.

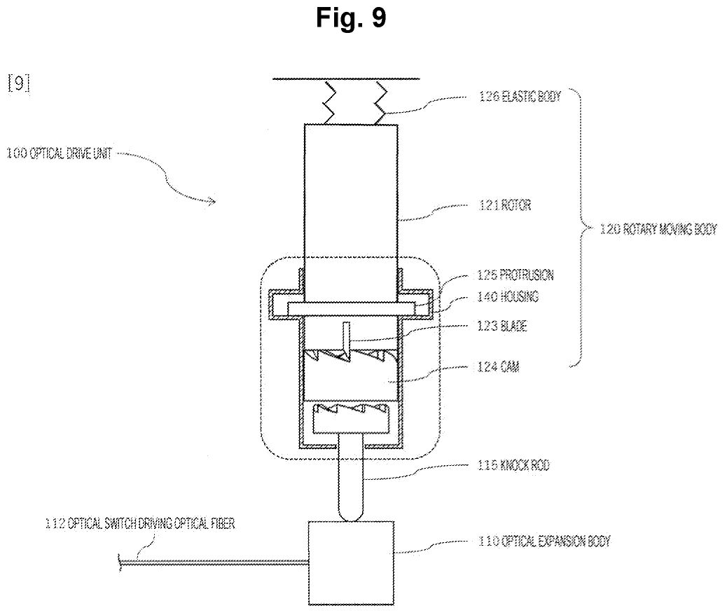

An operation of the optical drive unit 100 will be described with reference to FIGS. 9, 10, and 11. In FIGS. 9, 10, and 11, reference numeral 100 denotes the optical drive unit, reference numeral 110 denotes the optical expansion body, reference numeral 112 denotes the optical switch driving optical fiber, reference numeral 115 denotes the knock rod, reference numeral 120 denotes the rotary moving body, reference numeral 121 denotes the rotor, reference numeral 123 denotes the blade, reference numeral 124 denotes the cam, reference numeral 125 denotes the protrusion, reference numeral 126 denotes the elastic body, and reference numeral 140 denotes the housing. Note that FIGS. 9. 10, and 11 are views in which the inside of the housing 140 is seen through only within the dotted line of the optical drive unit 100.

In FIG. 9, when the optical expansion body 110 is not irradiated with light, the optical expansion body 110 contracts. When the optical expansion body 110 contracts, the knock rod 115 is separated from the blade 123. When the elastic body 126 presses the rotor 121, the slope of the blade 123 is pressed against the slope of the groove 124-1 of the cam.

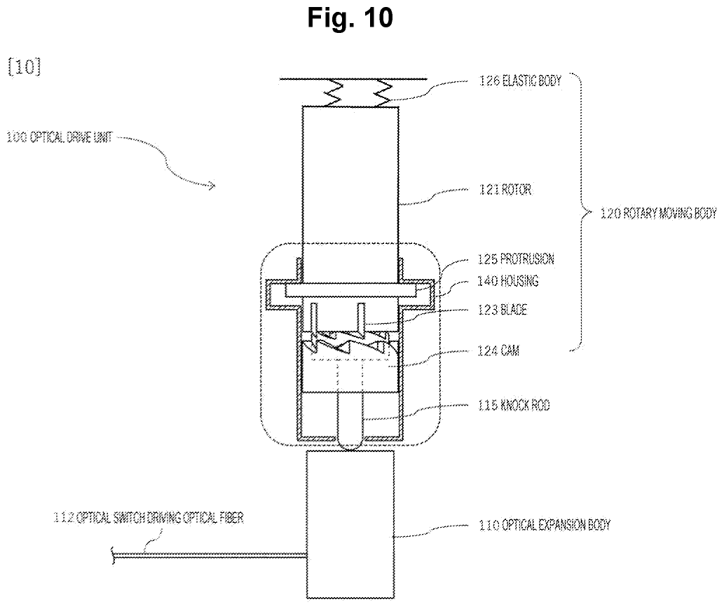

In FIG. 10, when the optical expansion body 110 is irradiated with the driving light through the optical switch driving optical fiber 112, the optical expansion body 110 expands. When the optical expansion body 110 expands, the knock rod 115 advances toward the rotor 121. The slope of the groove 115-1 of the knock rod is pressed against the slope of the blade 123, and the pressed slope of the blade 123 slides on the slope of the groove 115-1 of the knock rod, so that the rotor 121 rotates.

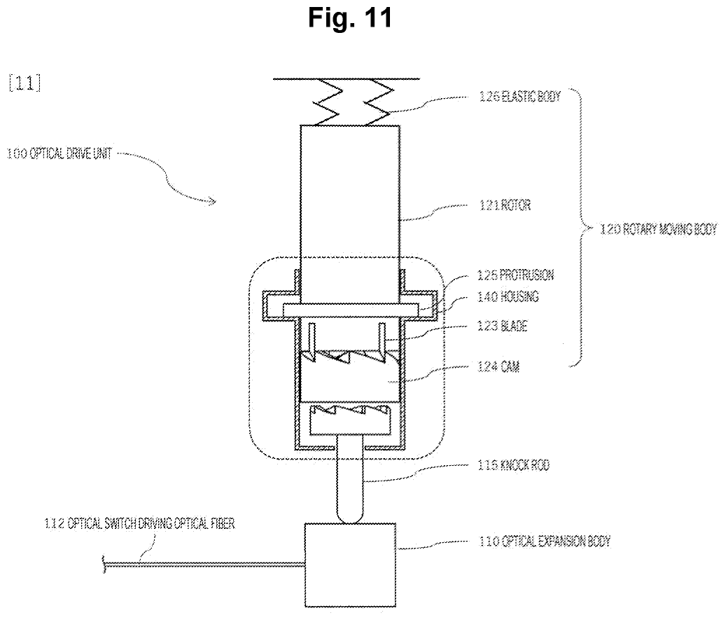

In FIG. 11, when the driving light to the optical expansion body 110 is blocked, the optical expansion body 110 contracts. When the optical expansion body 110 contracts, the knock rod 115 retreats from the rotor 121. When the elastic body 126 presses the rotor 121, the slope of the blade 123 is pressed against the slope of the groove 124-1 of the cam. When the pressed slope of the blade 123 slides on the slope of the cam groove 124-1, the rotor 121 further rotates. The blade 123 of the rotor 121 fits in an adjacent groove. In a series of operations from FIG. 9, the rotor 121 rotates by one groove of the groove 124-1 of the cam. By repeating the series of operations, the rotor 121 rotates by a certain angle at a time, and rotation at a desired angle can be realized.

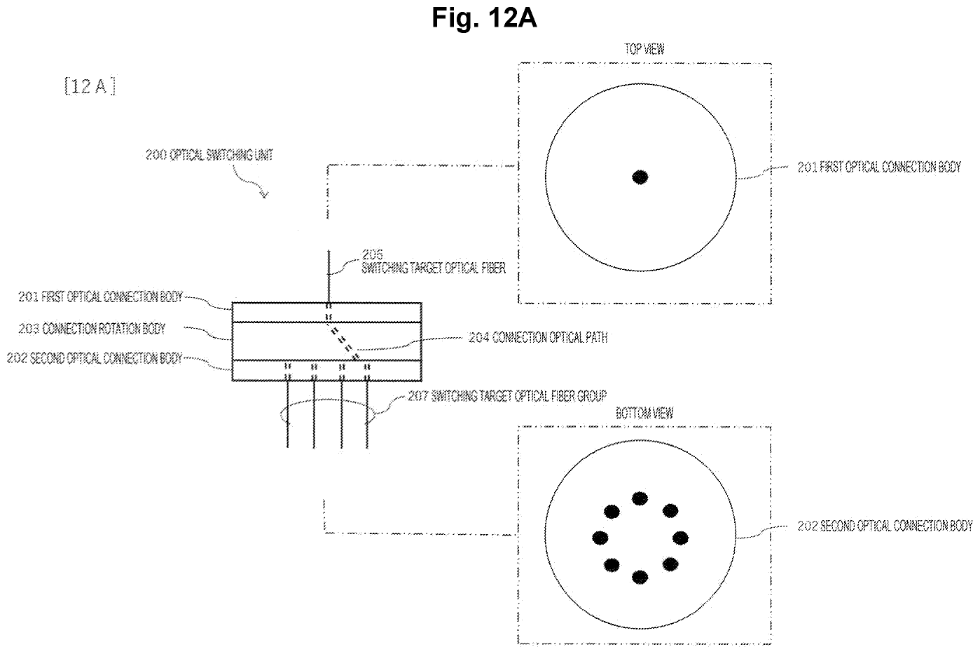

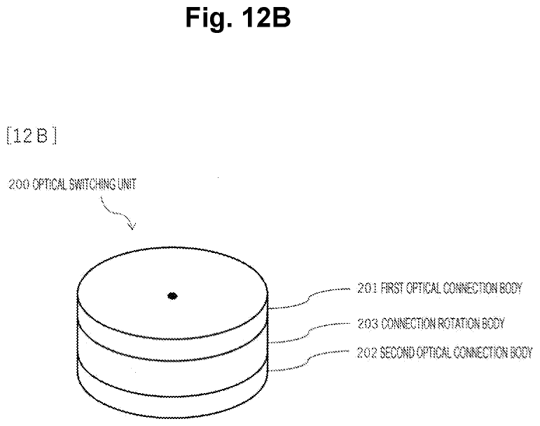

A configuration of the optical switching unit is illustrated in FIGS. 12A and 12B. FIG. 12A is a front view, a top view, and a bottom view of the optical switching unit, and FIG. 12B is a perspective view of the optical switching unit. In FIGS. 12A and 12B, reference numeral 200 denotes the optical switching unit, reference numeral 201 denotes the first optical connection body, reference numeral 202 denotes the second optical connection body, reference numeral 203 denotes the connection rotation body, reference numeral 204 denotes the connection optical path, reference numeral 206 denotes the switching target optical fiber, and reference numeral 207 denotes the switching target optical fiber group.

In FIGS. 12A and 12B, the optical switching unit 200 includes the first optical connection body 201, the second optical connection body 202, and the connection rotation body 203. One switching target optical fiber 206 is fixed to the first optical connection body 201. The black circle of the first optical connection body 201 in FIGS. 12A and 12B is a connection point of the switching target optical fiber 206. A plurality of optical fibers of the switching target optical fiber group 207 is fixed to the second optical connection body 202. The black circles of the second optical connection body 202 in FIGS. 12A and 12B are connection points of the switching target optical fiber group 207. The connection rotation body 203 rotates about the axis of the rotor 121 of the rotary moving body 120, and switches and connects one switching target optical fiber 206 fixed to the first optical connection body 201 in contact with one end surface and one optical fiber in the switching target optical fiber group 207 fixed to the second optical connection body 202 in contact with the other end surface.

Specifically, the connection rotation body 203 has the connection optical path 204. The connection optical path 204 optically connects the connection point at a center of rotation of one end surface perpendicular to the axis of the connection rotation body 203 and the connection point on a circumference having a radius of a predetermined distance from the center of rotation of the other end surface perpendicular to the axis.

The first optical connection body 201 is in contact with one end surface of the connection rotation body 203 and fixes one switching target optical fiber 206 at a position facing the center of rotation of the connection rotation body 203. The second optical connection body 202 is in contact with the other end surface of the connection rotation body 203, and fixes the plurality of optical fibers of the switching target optical fiber group 207 on a circumference having a radius of a predetermined distance from the center of rotation of the connection rotation body 203. When the connection rotation body 203 rotates, the connection optical path 204 of the connection rotation body 203 switches and connects one switching target optical fiber 206 of the first optical connection body 201 and one optical fiber in the switching target optical fiber group 207 of the second optical connection body 202.

A collimator lens may be provided at each end point of the connection optical path 204 of the one switching target optical fiber 206 and the connection rotation body 203, and may be connected by collimated light. In addition, collimator lenses may be provided at end points of the plurality of optical fibers of the switching target optical fiber group 207 and the connection optical path 204 of the connection rotation body 203, and may be connected by collimated light. Connection loss can be reduced by connection with collimated light.

As described above, the optical switch of the present disclosure does not require power supply, and the optical switch system using the optical switch can operate with low power consumption.

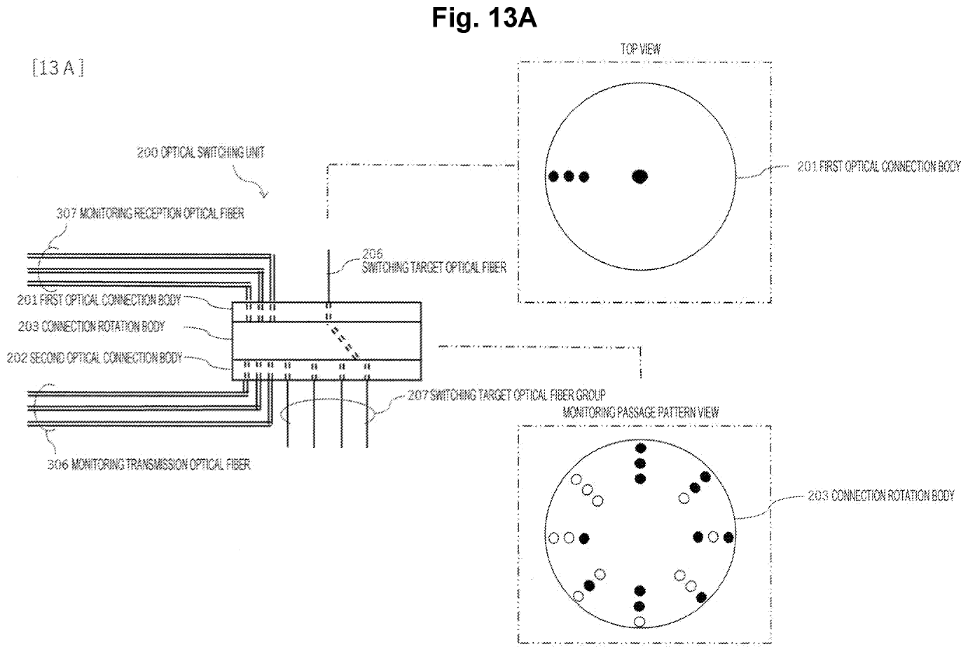

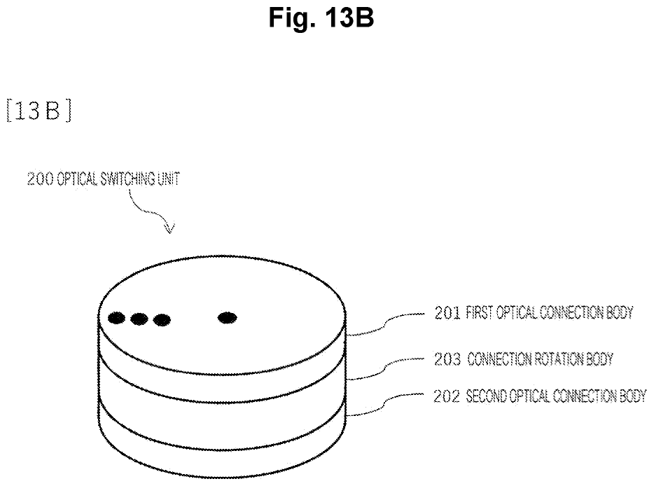

A part of the configuration of the monitoring function is illustrated in FIGS. 13A and 13B. FIG. 13A is a front view, a top view, and a monitoring passage pattern of the optical switching unit, and FIG. 13B is a perspective view of the optical switching unit. In FIGS. 13A and 13B, reference numeral 200 denotes the optical switching unit, reference numeral 201 denotes the first optical connection body, reference numeral 202 denotes the second optical connection body, reference numeral 203 denotes the connection rotation body, reference numeral 306 denotes the monitoring transmission optical fiber, and reference numeral 307 denotes the monitoring reception optical fiber.

The optical switching unit 200 also has a part of the monitoring function. Specifically, the connection rotation body 203 has a plurality of monitoring optical paths (not illustrated) that connects one end surface perpendicular to the rotation axis of the connection rotation body 203 and the other end surface perpendicular to the rotation axis of the connection rotation body 203. A connection and blocking pattern of the monitoring optical path varies depending on the rotation angle of the connection rotation body 203. The second optical connection body 202 fixes a plurality of the monitoring transmission optical fibers 306 that transmits the monitoring light from the other end surface of the connection rotation body 203 toward the monitoring optical paths (not illustrated). The first optical connection body 201 fixes a plurality of the monitoring reception optical fibers 307 that receives the monitoring light from the monitoring optical paths (not illustrated) toward one end surface of the connection rotation body 203.

A collimator lens may be provided at each end point of the monitoring transmission optical fiber 306 and the monitoring optical path of the connection rotation body 203, and may be connected by collimated light. Further, a collimator lens may be provided at each end point of the monitoring reception optical fiber 307 and the monitoring optical path of the connection rotation body 203, and may be connected by collimated light. Connection loss can be reduced by connection with collimated light.

Each of the connection and blocking patterns of light from the plurality of monitoring transmission optical fibers 306 to the plurality of monitoring reception optical fibers 307 uniquely changes by the rotation of the connection rotation body 203. For example, in the monitoring passage pattern view of FIG. 13A, the connection rotation body 203 is divided into eight divisions in units of 45 degrees in a rotation direction of the shaft. In the case of the units of 45 degrees, there are eight divisions of 0, 45, 90, 135, 180, 225, 270, and 315 degrees. Three optical fibers are used as the monitoring transmission optical fibers 306, and the three monitoring transmission optical fibers 306 are fixed at positions of 0 degrees on the end surface of the second optical connection body 202. Similarly, three optical fibers are used as the monitoring reception optical fibers 307, and the three monitoring reception optical fibers 307 are fixed at positions of 0 degrees on the end surface of the first optical connection body 201. In the connection rotation body 203, the connection and blocking patterns of the three monitoring transmission optical fibers 306 and the three monitoring reception optical fibers 307 are uniquely different depending on the rotation angle.

When the connection rotation body 203 rotates in the units of 45 degrees, the connection and blocking patterns from the three monitoring transmission optical fibers 306 to the three monitoring reception optical fibers 307 uniquely change. Assuming that the connection is 1, the blocking is 0, and the black circle is “1” and the white circle is “0” in the monitoring passage pattern view of FIG. 13A, it is possible to detect eight ways (=3 bits) of 111, 011, 101, 001, 110, 010, 100, and 000 from the center toward a peripheral edge according to the angles θ, 45, 90, 135, 180, 225, 270, and 315 degrees, respectively.

For example, in the case of the connection rotation body 203 that rotates in units of 10 degrees, the connection rotation body 203 is divided into thirty-six divisions for every 10 degrees in order to monitor thirty-six states, and six monitoring optical paths are arranged and six monitoring transmission optical fibers 306 and six monitoring reception optical fibers 307 are also required. The number of the monitoring optical paths of the connection rotation body 203 and the number of the monitoring transmission optical fibers 306 and the monitoring reception optical fibers 307 may be determined according to the unit of the rotation angle to be detected.

It is possible to know the rotation angle of the connection rotation body 203 from the rotation angle detected by the optical switching unit 200, and as a result, it is possible to monitor which optical fiber of the switching target optical fiber group 207 is connected to the switching target optical fiber 206 by the optical switching unit 200.

Here, the monitoring transmission optical fiber 306 is fixed to the second optical connection body 202 and the monitoring reception optical fiber 307 is fixed to the first optical connection body 201, but conversely, the monitoring transmission optical fiber 306 may be fixed to the first optical connection body 201 and the monitoring reception optical fiber 307 may be fixed to the second optical connection body 202 to connect and block the monitoring light.

As described above, the optical switch of the present disclosure having the monitoring function does not require power supply, and the optical switch system using the optical switch can operate with low power consumption.

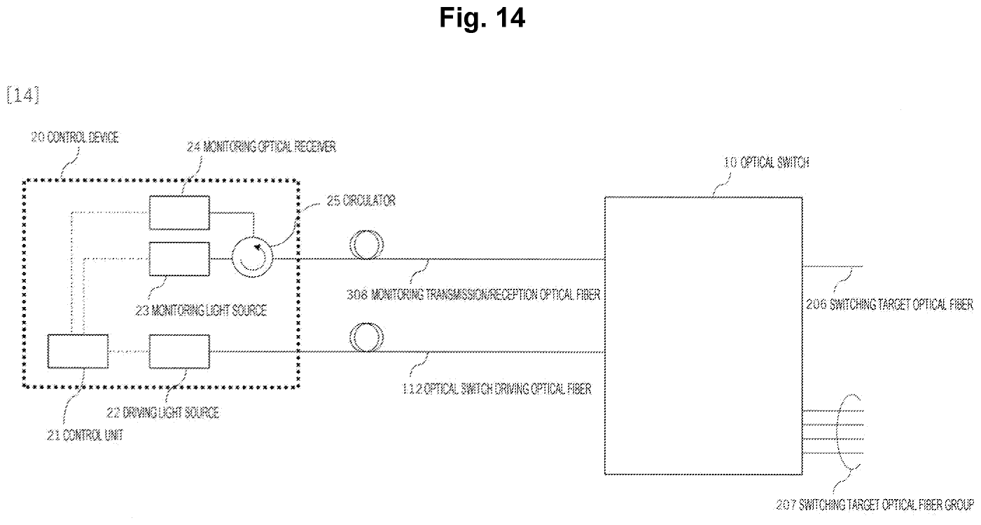

Another configuration of the optical switch system of the present disclosure is illustrated in FIG. 14. In FIG. 14, reference numeral 10 denotes the optical switch, reference numeral 112 denotes the optical switch driving optical fiber, reference numeral 20 denotes the control device, reference numeral 21 denotes the control unit, reference numeral 22 denotes the driving light source, reference numeral 23 denotes the monitoring light source, reference numeral 24 denotes the monitoring optical receiver, reference numeral 25 denotes a circulator, reference numeral 206 denotes the switching target optical fiber, reference numeral 207 denotes the switching target optical fiber group, and reference numeral 308 denotes a monitoring transmission/reception optical fiber.

The optical switch system includes the optical switch 10 and the control device 20. The control device 20 includes the control unit 21, the driving light source 22, the monitoring light source 23, the monitoring optical receiver 24, and the circulator 25. A difference from the optical switch system of FIG. 1 is that the control device 20 further includes the circulator 25, and the monitoring transmission/reception optical fiber 308 is used for monitoring the optical switch 10.

The control unit 21 causes the monitoring light source 23 to transmit the monitoring light. The monitoring light source 23 supplies the monitoring light to the optical switch 10 through the circulator 25 and the monitoring transmission/reception optical fiber 308. The monitoring optical receiver 24 receives the monitoring light from the optical switch 10 via the monitoring transmission/reception optical fiber 308 and the circulator 25. The control unit 21 receives a reception signal from the monitoring optical receiver 24 and monitors whether the optical switch 10 is operating as instructed.

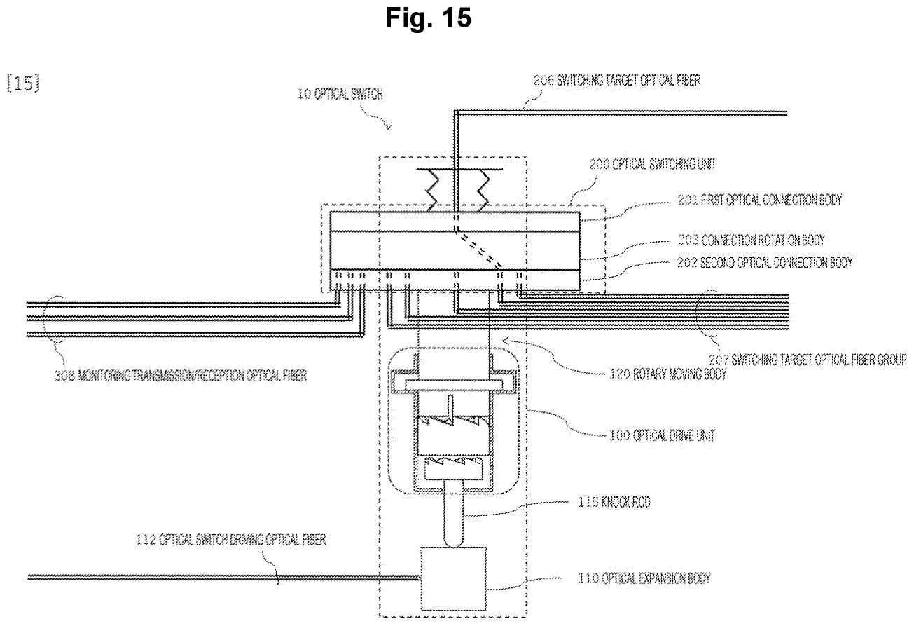

Another configuration of the optical switch of the present disclosure is illustrated in FIG. 15. In FIG. 15, reference numeral 10 denotes the optical switch, reference numeral 100 denotes an optical drive unit, reference numeral 110 denotes an optical expansion body, reference numeral 112 denotes the optical switch driving optical fiber, reference numeral 115 denotes a knock rod, reference numeral 120 denotes a rotary moving body, reference numeral 200 denotes an optical switching unit, reference numeral 201 denotes a first optical connection body, reference numeral 202 denotes a second optical connection body, reference numeral 203 denotes a connection rotation body, reference numeral 206 denotes the switching target optical fiber, reference numeral 207 denotes the switching target optical fiber group, and reference numeral 308 denotes the monitoring transmission/reception optical fiber. The optical drive unit 100 has the same configuration as the optical switch of FIG. 2. The configuration of the optical switching unit 200 is different from that of the optical switch of FIG. 2. Note that FIG. 15 is a view in which the inside of the housing 140 is seen through only within the dotted line of the optical drive unit 100.

It is possible to detect the rotation angle of the connection rotation body 203 in the optical switching unit 200 when the second connection rotation body 203 of the optical switching unit 200 rotates by a certain angle, and light enters the second optical connection body 202 from the monitoring transmission/reception optical fiber 308, and depending on how the light is reflected and blocked and re-enters the monitoring transmission/reception optical fiber 308. Therefore, the control device 20 can monitor which optical fiber in the switching target optical fiber group 207 is connected and blocked with the switching target optical fiber 206 by the optical switch 10 as instructed.

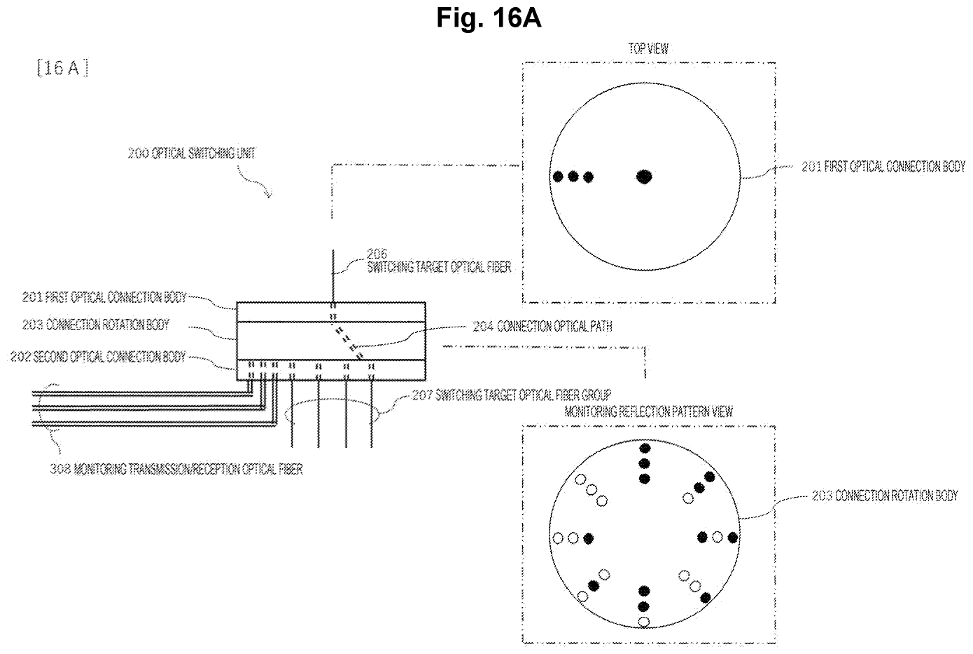

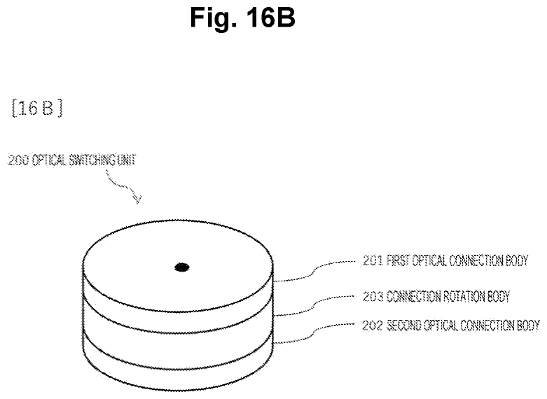

A part of the configuration of the monitoring function is illustrated in FIGS. 16A and 16B. FIG. 16A is a front view, a top view, and a monitoring reflection pattern view of the optical switching unit, and FIG. 16B is a perspective view of the optical switching unit. In FIGS. 16A and 16B, reference numeral 200 denotes the optical switching unit, reference numeral 201 denotes the first optical connection body, reference numeral 202 denotes the second optical connection body, reference numeral 203 denotes the connection rotation body, and reference numeral 308 denotes the monitoring transmission/reception optical fiber.

The optical switching unit 200 also has a part of the monitoring function. Specifically, the connection rotation body 203 includes a reflection plate (not illustrated) having a plurality of reflection and blocking portions on the other end surface perpendicular to the rotation axis of the connection rotation body 203. A reflection and blocking pattern varies depending on the rotation angle of the connection rotation body 203. The second optical connection body 202 transmits the monitoring light from the other end surface of the connection rotation body 203 toward the reflection plate, and fixes a plurality of the monitoring transmission/reception optical fibers 308 that receives the monitoring light reflected from the reflection plate toward the other end surface of the connection rotation body 203.

A collimator lens may be provided at an end point of the monitoring transmission/reception optical fiber 308 to reflect and block collimated light. Connection loss can be reduced by connection with collimated light.

The reflection and blocking patterns of light from the plurality of monitoring transmission/reception optical fibers 308 uniquely change by the rotation of the connection rotation body 203. For example, in the monitoring reflection pattern view of FIG. 16A, the connection rotation body 203 is divided into eight divisions in units of 45 degrees in a rotation direction of the shaft. In the case of the units of 45 degrees, there are eight divisions of 0, 45, 90, 135, 180, 225, 270, and 315 degrees. Three optical fibers are used as the monitoring transmission/reception optical fibers 308, and the three monitoring transmission/reception optical fibers 308 are fixed at positions of 0 degrees on the end surface of the second optical connection body 202. In the connection rotation body 203, the reflection and blocking patterns of the three monitoring transmission/reception optical fibers 308 are uniquely different depending on the rotation angle.

When the connection rotation body 203 rotates in units of 45 degrees, the reflection and blocking patterns of the three monitoring transmission/reception optical fibers 308 uniquely change. Assuming that the reflection is 1, the blocking is 0, and the black circle is “1” and the white circle is “0” in the monitoring reflection pattern view of FIG. 16A, it is possible to detect eight ways (=3 bits) of 111, 011, 101, 001, 110, 010, 100, and 000 from the center toward a peripheral edge according to the angles 0, 45, 90, 135, 180, 225, 270, and 315 degrees, respectively.

In the case of reflection from the three monitoring transmission/reception optical fibers 308, it is sufficient to reflect the monitoring light from the monitoring transmission/reception optical fibers 308 by the connection rotation body 203, and to return the monitoring light to the monitoring transmission/reception optical fibers 308. In the case of blocking the three monitoring transmission/reception optical fibers 308, it is sufficient not to reflect or to absorb the monitoring light from the monitoring transmission/reception optical fibers 308 or to reflect the monitoring light in a different direction from the monitoring transmission/reception optical fibers 308 by the connection rotation body 203, so as not to return the monitoring light to the monitoring transmission/reception optical fibers 308.

The number of reflections and blockings of the connection rotation body 203 and the number of monitoring transmission/reception optical fibers 308 are determined according to the unit of the rotation angle to be detected, which is a same as in FIG. 13A.

It is possible to know the rotation angle of the connection rotation body 203 from the rotation angle detected by the optical switching unit 200, and as a result, it is possible to monitor which optical fiber of the switching target optical fiber group 207 is connected to the switching target optical fiber 206 by the optical switching unit 200.

Here, the monitoring transmission/reception optical fiber 308 is fixed to the second optical connection body 202, but the monitoring transmission/reception optical fiber 308 may be fixed to the first optical connection body 201 to reflect and block the monitoring light.

As described above, the optical switch of the present disclosure having the monitoring rotation unit does not require power supply, and the optical switch system using the optical switch can operate with low power consumption.

### INDUSTRIAL APPLICABILITY

The present disclosure can be applied to communications industries.

### REFERENCE SIGNS LIST

10 Optical switch
20 Control device
21 Control unit
22 Driving light source
23 Monitoring light source
24 Monitoring optical receiver
25 Circulator
100 Optical drive unit
110 Optical expansion body
110-1 Optical expansion member
111 Lever
112 Optical switch driving optical fiber
115 Knock rod
115-1 Groove of knock rod
115-2 Pressing portion
120 Rotary moving body
121 Rotor
123 Blade
124 Cam
124-1 Groove of cam
124-2 Knock hole of cam
125 Protrusion
126 Elastic body
127 Shaft hole
140 Housing
141 Rotor hole
142 Recess
143 Knock hole of housing
200 Optical switching unit
201 First optical connection body
202 Second optical connection body
203 Connection rotation body
204 Connection optical path
206 Switching target optical fiber
207 Switching target optical fiber group
306 Monitoring transmission optical fiber
307 Monitoring reception optical fiber
308 Monitoring transmission/reception optical fiber

1. An optical switch comprising:
an optical drive unit including
an optical expansion body that expands by irradiation with light and contracts by blocking of light,
a knock rod that converts the expansion and contraction of the optical expansion body into linear motion that reciprocates by a certain distance, and
a rotary moving body that includes a rotor, and converts the linear motion into rotary motion that rotates by a certain angle about an axis of the rotor in accordance with the linear motion that reciprocates by a certain distance by the knock rod; and
an optical switching unit including
a first optical connection body to which one switching target optical fiber is fixed,
a second optical connection body to which each optical fiber of a switching target optical fiber group is fixed, and
a connection rotation body that is fixed to the rotor of the rotary moving body, rotates about the axis of the rotor, and switches and connects the one switching target optical fiber fixed to the first optical connection body in contact with one end surface and one optical fiber in the switching target optical fiber group fixed to the second optical connection body in contact with the other end surface.

2. The optical switch according to claim 1, wherein
the rotary moving body includes
a blade fixed to an end surface of the rotor on a side of the knock rod and having a tip with a flat slope on the side of the knock rod,
a cylindrical cam that is fixed inside a housing and receives the slope of the blade with a slope of a sawtooth groove provided in an annular shape in an end surface on a side of the blade and having an inclination in a same direction as the slope of the blade, and
an elastic body that is fixed to the housing and pushes the rotor back toward the cam,
the knock rod is a sawtooth groove that reciprocates inside a cylindrical shape of the cam, and has a groove in an annular shape in an end surface on the side of the blade, the groove being a sawtooth groove shifted by a half pitch at a same cycle as the sawtooth groove of the cam, and having a slope with an inclination in a same direction as the slope of the blade,
when the optical expansion body is contracted, the slope of the blade is pressed against the slope of the sawtooth groove of the cam by the elastic body,
when the optical expansion body expands, the knock rod advances toward the rotor, the slope of the sawtooth groove of the knock rod is pressed against the slope of the blade, and the pressed slope of the blade slides on the slope of the sawtooth groove of the knock rod, so that the rotor rotates, and
when the optical expansion body turns from expansion to contraction, the knock rod retracts from the rotor, the rotor pushed back by the elastic body faces the cam, the slope of the blade is pressed against the slope of the sawtooth groove of the cam, and the pressed slope of the blade slides on the slope of the sawtooth groove of the cam, so that the rotor rotates.

3. The optical switch according to claim 1, wherein the optical expansion body is made of a black material or a material containing air bubbles inside the material.

4. The optical switch according to claim 1, wherein
the connection rotation body includes a connection optical path that connects a center of rotation of the one end surface perpendicular to an axis and a connection point disposed on a circumference having a radius of a predetermined distance from a center of rotation of the other end surface perpendicular to the axis,
the first optical connection body is in contact with the one end surface of the connection rotation body and fixes the one switching target optical fiber at a position facing the center of rotation of the connection rotation body,
the second optical connection body is in contact with the other end surface of the connection rotation body and fixes the optical fibers of the switching target optical fiber group on a circumference having a radius of a predetermined distance from the center of rotation of the connection rotation body, and
the connection optical path switches and connects the one switching target optical fiber of the first optical connection body and one optical fiber in the switching target optical fiber group of the second optical connection body when the connection rotation body rotates.

5. The optical switch according to claim 1, wherein
the connection rotation body further includes a plurality of monitoring optical paths that connects the one end surface and the other end surface, and has different connection and blocking patterns depending on a rotation angle,
the second optical connection body further fixes a plurality of monitoring transmission optical fibers that transmits the monitoring light from the other end surface of the connection rotation body toward the monitoring optical paths,
the first optical connection body further fixes a plurality of monitoring reception optical fibers that receives the monitoring light from the monitoring optical paths toward the one end surface of the connection rotation body, and
each of the connection and blocking patterns of light from the plurality of monitoring transmission optical fibers to the plurality of monitoring reception optical fibers is uniquely changed by the rotation of the connection rotation body.

6. The optical switch according to claim 1, wherein
the connection rotation body further includes, on the one end surface, a reflection plate having a reflection and blocking pattern different depending on the rotation angle,
the second optical connection body further fixes a plurality of monitoring transmission/reception optical fibers that transmits the monitoring light from the other end surface of the connection rotation body toward the reflection plate and receives the reflected monitoring light from the reflection plate toward the other end surface of the connection rotation body, and
each of reflection and non-reflection patterns of light in the plurality of monitoring transmission/reception optical fibers is uniquely changed by the rotation of the connection rotation body.

7. An optical switch system comprising:
the optical switch according to claim 1; and
a control device including a driving light source that supplies light for causing expansion to the optical expansion body and a control unit that instructs the driving light source to perform irradiation and blocking.

8. An optical switch system comprising:
the optical switch according to claim 5; and
a control device including
a driving light source that supplies light for causing expansion to the optical expansion body,
a monitoring light source that transmits monitoring light toward the optical switching unit,
a monitoring optical receiver that receives the monitoring light from the optical switching unit, and
a control unit that instructs the driving light source to perform irradiation and blocking, instructs the monitoring light source to perform supply and blocking, and monitors which optical fiber of the switching target optical fiber group is connected to and disconnected from the switching target optical fiber according to a signal from the monitoring optical receiver.
